(19) United States
(12) Patent Application Publication
(10) Pub. No.: US 2011/0132633 A1
(43) Pub. Date: Jun. 9, 2011

(54) PROTECTIVE JACKET IN A COAXIAL CABLE

(75) Inventor: Noah Montena, Syracuse, NY (US)

(73) Assignee: JOHN MEZZALINGUA ASSOCIATES, INC., East Syracuse, NY (US)

(21) Appl. No.: 12/631,639

(22) Filed: Dec. 4, 2009

(51) Int. Cl. H01B 11/18; H01B 13/20

(52) U.S. Cl. 174/28; 174/107; 29/828

(57) ABSTRACT

A protective jacket in a coaxial cable. In one example embodiment, a coaxial cable includes two or more internal components and a jacket surrounding the internal components. The internal components include an electrical conductor configured to propagate a signal and an outer conductor surrounding the electrical conductor. The jacket includes two or more protruding portions and two or more recessed portions. Each recessed portion is positioned between two of the protruding portions. Each of the protruding portions makes contact with the outer conductor and each of the recessed portions does not make contact with the outer conductor. A method for manufacturing a coaxial cable with a protective jacket is also disclosed.

### BACKGROUND

Coaxial cable often includes an outer protective jacket that serves to protect the internal components of the cable from external contaminants and/or forces. For example, a typical coaxial cable includes a center conductor surrounded by a dielectric, an outer conductor, and a protective jacket. Some protective jackets are made from a relatively rigid material in order to protect the internal components of the cable. A cable with a rigid protective jacket can be especially useful when the cable is installed outdoors, whether aerially or underground, due to the extra protection provided by such a jacket.

Unfortunately, the rigidity of the protective jacket can give rise to several problems. For example, a coaxial cable with a rigid protective jacket can be very difficult to terminate with a typical cable connector. A typical cable connector utilizes a post (or similar structure) that must slide underneath and thereby expand the protective jacket to be properly installed. A rigid protective jacket can require a high insertion force to fully and properly insert the post underneath the jacket. Further, because plastics become more rigid as they are exposed to lower temperatures, the required amount of insertion force increases with any drop in the ambient temperature of the cable. Consequently, cold weather installation of a typical cable connector can be very difficult or even impossible on a cable that includes a rigid protective jacket.

### SUMMARY OF SOME EXAMPLE EMBODIMENTS

In general, example embodiments of the present invention relate to a jacket that serves to protect internal components of a coaxial cable. Moreover, disclosed embodiments provide a cable jacket that reduces the amount of insertion force required to fully insert the post of a typical cable connector underneath the jacket, even when the cable is exposed to low temperature conditions.

In one example embodiment, a coaxial cable includes two or more internal components and a jacket surrounding the internal components. The internal components include an electrical conductor configured to propagate a signal and an outer conductor surrounding the electrical conductor. The jacket includes two or more protruding portions and two or more recessed portions. Each recessed portion is positioned between two of the protruding portions. Each of the protruding portions makes contact with the outer conductor and each of the recessed portions does not make contact with the outer conductor.

In another example embodiment, a coaxial cable includes a center conductor configured to propagate a signal, a dielectric surrounding the center conductor, an outer conductor surrounding the dielectric, and a jacket surrounding the outer conductor. The jacket includes two or more recessed portions and two or more protruding portions. Each protruding portion is positioned between two of the recessed portions.

In yet another example embodiment, a method for manufacturing a coaxial cable having two or more internal components is disclosed. The internal components include an electrical conductor configured to propagate a signal and an outer conductor surrounding the electrical conductor. During this method, a jacket is extruded so as to surround the internal components. The jacket is extruded so as to include two or more protruding portions and two or more recessed portions. Each recessed portion is positioned between two of the protruding portions. Each of the protruding portions abuts the outer conductor and each of the recessed portions is spaced apart from the outer conductor

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Moreover, it is to be understood that both the foregoing general description and the following detailed description of the present invention are exemplary and explanatory and are intended to provide further explanation of the invention as claimed.

### BRIEF DESCRIPTION OF THE DRAWINGS

Aspects of example embodiments of the present invention will become apparent from the following detailed description of example embodiments given in conjunction with the accompanying drawings, in which:

FIG. 1A is a perspective view of an example coaxial cable that terminates on one end with an example connector and that is prepared for termination on the other end with another example connector;

FIG. 1B is a cross-sectional view of the example coaxial cable of FIG. 1A;

FIG. 1C is a perspective view of a portion of the coaxial cable of FIG. 1A with portions of each layer cut away;

FIG. 1D is another cross-sectional view of the example coaxial cable and one of the example connectors of FIG. 1A;

FIGS. 1E and 1F are example cross-sectional views of the example coaxial cable and one of the example connectors of FIG. 1A; and

FIG. 2 is a flowchart of an example method for manufacturing the example coaxial cable of FIG. 1A.

### DETAILED DESCRIPTION OF SOME EXAMPLE EMBODIMENTS

Example embodiments of the present invention relate to a jacket that serves to protect internal components of a coaxial cable. In the following detailed description of some example embodiments, reference will now be made in detail to example embodiments of the present invention which are illustrated in the accompanying drawings. Wherever possible, the same reference numbers will be used throughout the drawings to refer to the same or like parts. These embodiments are described in sufficient detail to enable those skilled in the art to practice the invention. Other embodiments may be utilized and structural changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

### I. Example Coaxial Cable

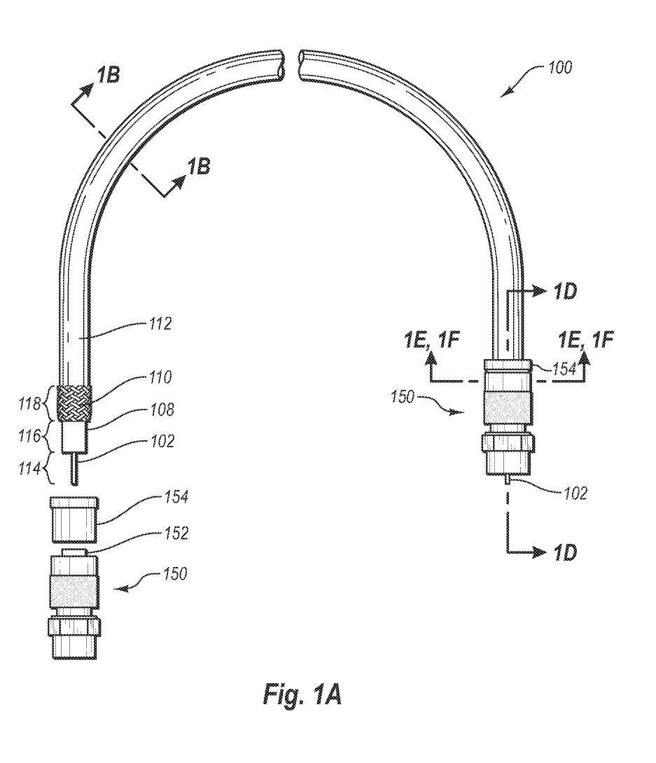

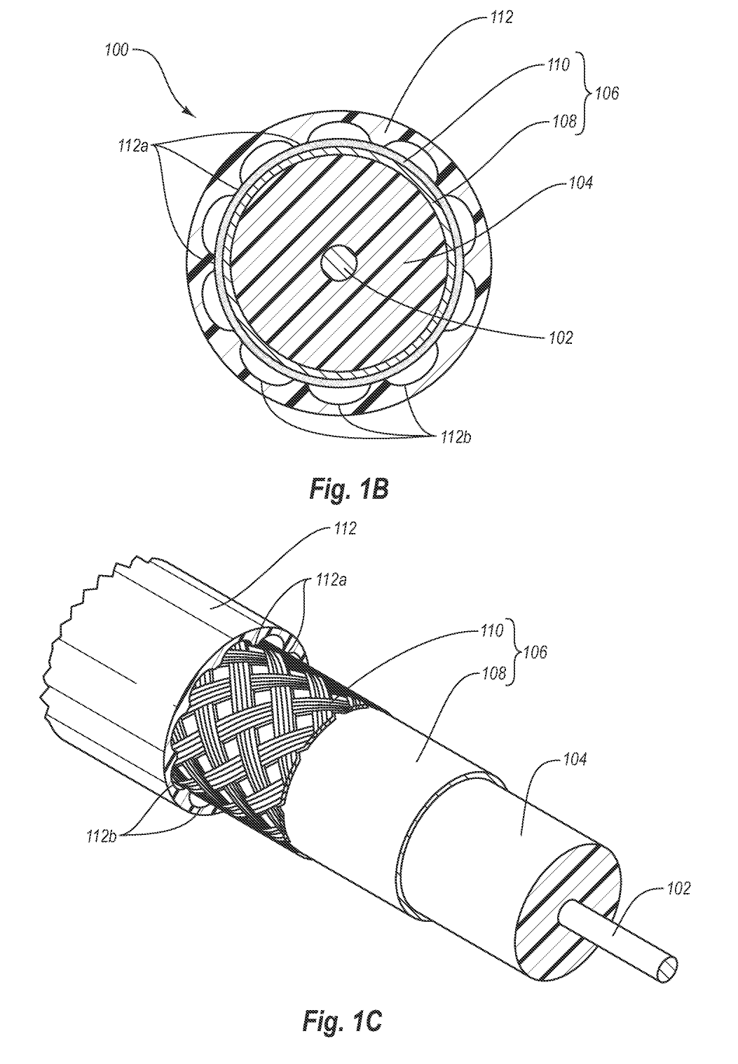

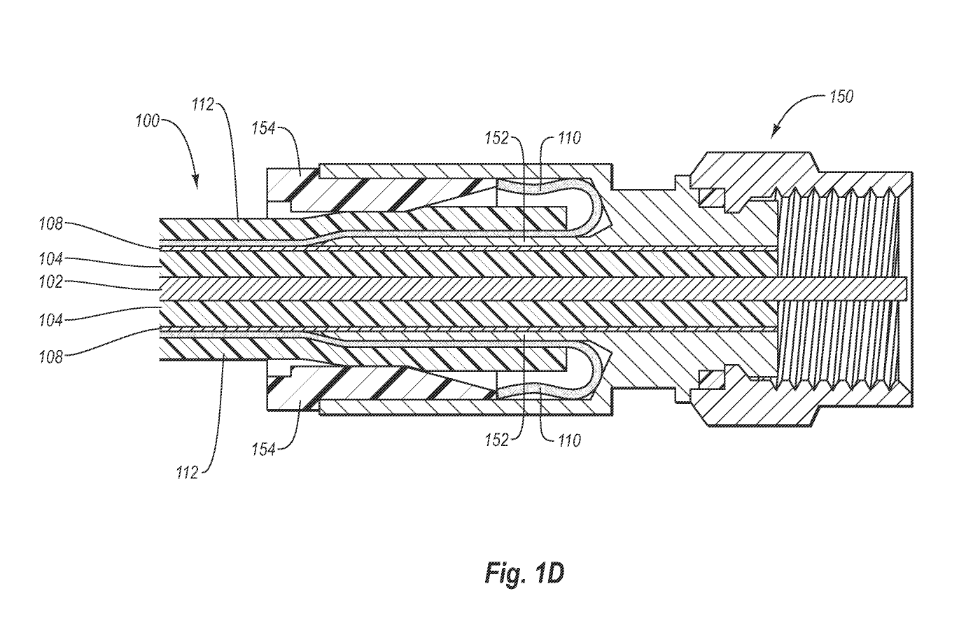

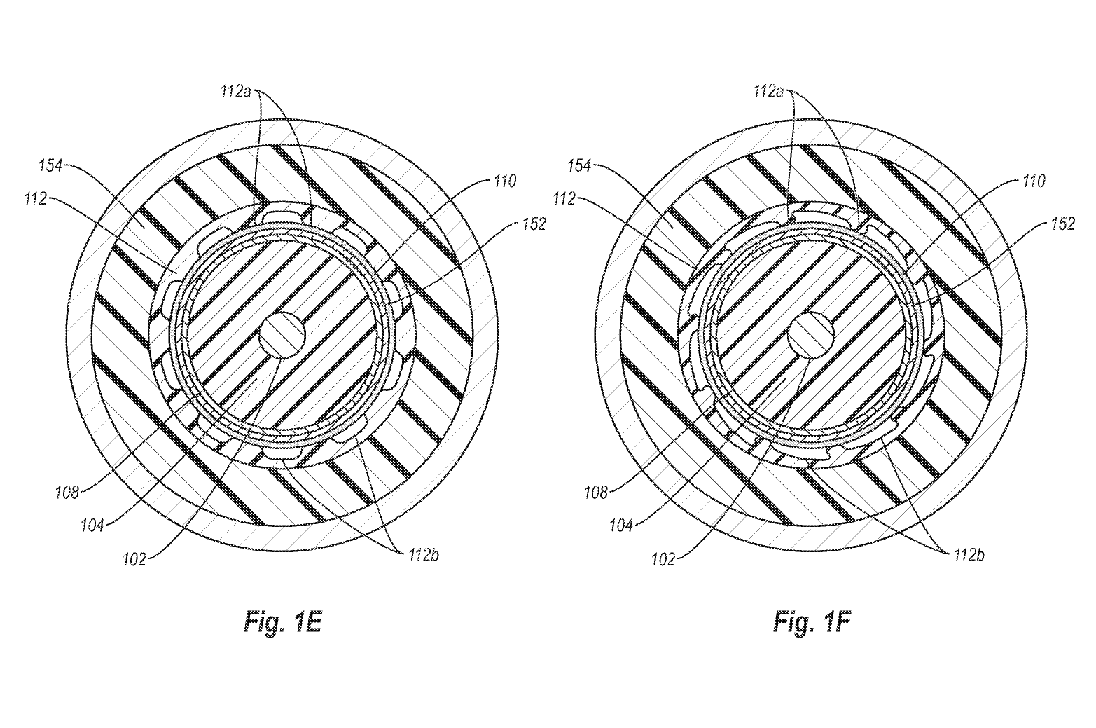

With reference first to FIG. 1A, an example coaxial cable 100 is disclosed. The example coaxial cable 100 can be any type of coaxial cable including, but not limited to, 50 Ohm and 75 Ohm coaxial cable. As disclosed in FIG. 1A, the example coaxial cable 100 is terminated on the right side of FIG. 1A with an example connector 150, and is prepared for termination on the left side of FIG. 1A with a second identical connector 150, as discussed in greater detail below. Although connectors 150 are disclosed in FIG. 1A as F-type male connectors, it is understood that cable 100 can also be terminated with other types of male and/or female connectors (not shown).

With continuing reference to FIG. 1A, and with reference also to FIGS. 1B and 1C, the coaxial cable 100 is a standard-shield coaxial cable that generally includes a center conductor 102 surrounded by a dielectric 104, an outer conductor 106 including a conductive tape 108 and a conductive braid 110 surrounding the dielectric 104, and a jacket 112 surrounding the outer conductor 106. As used herein, the phrase “surrounded by” refers to an inner layer generally being encased by an outer layer. However, it is understood that an inner layer may be “surrounded by” an outer layer without the inner layer being immediately adjacent to the outer layer. The term “surrounded by” thus allows for the possibility of intervening layers. Each of these components of the example coaxial cable 100 will now be discussed in turn.

The center conductor 102 is positioned at the core of the example coaxial cable 100. The center conductor 102 is configured to carry a range of electrical current (amperes) as well as propagate an RF/electronic digital signal. In some example embodiments, the center conductor 102 is formed from solid copper, copper-clad aluminum (CCA), copper-clad steel (CCS), or silver-coated copper-clad steel (SCCCS), although other conductive materials are possible. For example, the center conductor 102 can be formed from any type of conductive metal or alloy. In addition, the center conductor 102 can be solid, hollow, stranded, corrugated, plated, or clad, for example.

The dielectric 104 surrounds the center conductor 102, and generally serves to support and insulate the center conductor 102 and the outer conductor 106. Although not shown in the figures, a bonding agent, such as a polymer, can be employed to bond the dielectric 104 to the center conductor 102. In some example embodiments, the dielectric 104 can be, but is not limited to, taped, solid, or foamed polymer or fluoropolymer. For example, the dielectric 104 can be foamed polyethylene (PE).

The tape 108 of the outer conductor 106 surrounds the dielectric 104 and generally serves to minimize the ingress and egress of high frequency electromagnetic radiation to/from the center conductor 102. For example, in some applications, the tape 108 can shield against electromagnetic radiation with a frequency greater than or equal to about 50 MHz. The tape 108 is a laminate tape that can include, but is not limited to, the following layers: aluminum/polymer, bonding agent/ aluminum/polymer, bonding agent/aluminum/polymer/aluminum, or aluminum/ polymer/aluminum, for example. It is understood, however, that the discussion herein of tape is not limited to tape having any particular combinations of layers.

The braid 110 of the outer conductor 106 surrounds the tape 108 of the outer conductor 106. The braid 110 generally serves to minimize the ingress and egress of low frequency electromagnetic radiation to/from the center conductor 102. For example, in some applications, the braid 110 can shield against electromagnetic radiation with a frequency less than about 50 MHz. In addition, the braid 110 also serves to give structural support to, and thereby strengthen, the coaxial cable 100. The braid 110 can be formed from inter-woven, fine gauge aluminum or copper wires, such as 34 American wire gauge (AWG) wires, for example. It is understood, however, that the discussion herein of braid is not limited to braid formed from any particular type or size of wire.

The jacket 112 surrounds the dielectric 104, and generally serves to protect the internal components of the coaxial cable 100 from external contaminants, such as dust, moisture, and oils, for example. In a typical embodiment, the jacket 112 also functions to limit the bending radius of the cable to prevent kinking, and functions to protect the cable (and its internal components) from being crushed or otherwise misshapen from an external force.

As noted elsewhere herein, the example jacket 112 can be formed from a relatively rigid material such as, but not limited to, polyethylene (PE), high-density polyethylene (HDPE), low-density polyethylene (LDPE), linear low-density polyethylene (LLDPE), or some combination thereof. The actual material used might be indicated by the particular application/environment contemplated. For example, the relatively high rigidity and stiffness provided by PE indicates that this material might be employed in coaxial cable intended for underground or aerial outdoor installation due to its tensile strength, impact resistance, crush resistance, compression resistance, abrasion resistance, relatively low cost, and moisture resistance. These characteristics of PE make it superior in performance as a jacket material as compared to softer materials, such as rubberized polyvinyl chloride (PVC). However, as previously noted, jackets made entirely from a rigid, substantially non-compressible material such as PE tend to require an excessive amount of insertion force to fully insert the post of a cable connector (or similar component) underneath the jacket.

For this reason, the example jacket 112 includes alternating protruding portions 112a and recessed portions 112b as disclosed in FIGS. 1B and 1C. Each recessed portion 112b is positioned between two of the protruding portions 112a and each protruding portion 112a is positioned between two of the recessed portions 112b. As disclosed in FIGS. 1B and 1C, each of the protruding portions 112a makes contact with the braid 110 of the outer conductor 106 and each of the recessed portions 112b does not make contact with the braid 110 of the outer conductor 106. Further, each of the protruding portions 112a abuts the outer conductor 106, while each of the recessed portions 112b is spaced apart from the outer conductor 106.

For example, as disclosed in FIGS. 1B and 1C, the contact surface area between each protruding portion 112a and the outer conductor 106 is about one-third of the surface area of the outer conductor 106 underneath each recessed portion 112b. Accordingly, the contact surface area between the jacket 112 and the outer conductor 106 is about one-fourth the contact surface area of a standard coaxial cable with a rigid jacket that lacks recessed portions (a standard rigid-jacketed cable). The relative decrease in the amount of jacket material making contact with the internal components of the coaxial cable 100 reduces the amount of insertion force required to fully insert the post of a cable connector underneath the jacket 112. This is due at least in part to the decrease in the amount of jacket material that the post must displace as the post is inserted underneath the jacket 112. It is understood that the contact surface area between each protruding portion 112a and the outer conductor 106 can be less than about one-third of the surface area of the outer conductor 106 underneath each recessed portion 112b.

Although each of the protruding portions 112a is disclosed in the Figures as being uniform in size and shape, it is understood that the protruding portions 112a may instead be differents sizes and/or shapes. Similarly, the recessed portions 112b may be different sizes and/or shapes instead of being uniform in size and/or shape as disclosed in the Figures. In addition, although the contact surface area between each protruding portion 112a and the outer conductor 106 is disclosed in the Figures as being greater than the surface area of the outer conductor 106 underneath each recessed portion 112b, it is understood that the contact surface area between each protruding portion 112a and the outer conductor 106 may instead be equal to or greater than the surface area of the outer conductor 106 underneath each recessed portion 112b.

With continued reference to FIGS. 1B and 1C, the protruding portions 112a generally run the length of the coaxial cable 100. For example, each protruding portion 112a may run in a substantially straight line parallel to the center conductor 102 along the length of the coaxial cable 100, or each protruding portion may be helically wrapped along the length of the coaxial cable 100. A bending bias of the braid 110 tends to cause the coaxial cable 100 to bend in a certain direction when a force is applied perpendicular to the coaxial cable 100. The extent of any helically wrapping of the protruding portions 112a may be configured to either contribute to or offset the bending bias of the braid 110, thereby either increasing or decreasing, respectively, the effect of the bending bias of the braid 110 on the coaxial cable 100.

With continued reference to FIGS. 1B and 1C, the space between each recessed portion 112b and the braid 110 of the outer conductor 106 may be filled with a flooding compound (not shown). For example, the flooding compound may be, but is not limited to, polybutane, amorphous polypropylene, polyisobtylene, or some combination thereof. The flooding compound can later prevent moisture from entering this space and may also function as a lubricant to facilitate the slipping of a post of a cable connector underneath the jacket 112.

With reference now to FIG. 1D, and also with reference again to FIG. 1A, aspects of termination of the example cable 100 with the example connector 150 are disclosed. As disclosed on the left side of FIG. 1A, prior to the termination of the example coaxial cable 100 with the connector 150, a quarter-inch section 114 of the center conductor 102 and a quarter-inch section 116 of the tape 108 are exposed. The quarter-inch section 114 of the center conductor 102 is exposed by removing the jacket 112, the braid 110, the tape 108, and the dielectric 104. The quarter-inch section 116 of the tape 108 is exposed by removing the jacket 112 and then folding back a quarter-inch section 118 of the braid 110 over the outside of the jacket 112. Next, a circular post 152 (or similar structure) of the cable connector 150 can be inserted between the tape 108 and the braid 110. Finally, a wedge portion 154 of the connector 150 can be slid down the coaxial cable 100 to firmly attach the connector 150 to the coaxial cable 100.

With continuing reference to FIG. 1D, and with reference now also to FIGS. 1E and 1F, additional aspects of termination of the example cable 100 with the example connector 150 are disclosed. As disclosed in FIG. 1E, when the circular post 152 of the cable connector 150 is inserted between the tape 108 and the braid 110, the protruding portions 112a can compress and expand sideways without causing the outside perimeter of the jacket 112 to be displaced as significantly as with a standard rigid-jacketed cable. As disclosed FIG. 1F, when the circular post 152 of the cable connector 150 is inserted between the tape 108 and the braid 110, the protruding portions 112a can instead buckle in a clockwise direction, due to twisting the cable connector 150 in a clockwise direction during insertion for example, without causing the outside perimeter of the jacket 112 to be displaced as significantly as with a standard rigid-jacketed cable. It is understood that some of the protruding portions 112a may buckle in a clockwise direction while the other protruding portions 112a buckle in a counterclockwise direction. It is further understood that each of the protruding portions 112a may be shaped so as to be predisposed to buckle in a particular direction. As used herein, the term “buckle” generally refers to the folding or collapsing of a protruding portion of a jacket.

The relative decrease in the amount of jacket material making contact with the internal components of the coaxial cable 100 reduces the amount of insertion force required to fully insert the post 152 of the connector 150 underneath the jacket 112. This is due in part to the decrease in the amount of jacket material that the post 152 must displace, as compared to a standard rigid jacketed cable, as the post 152 is inserted underneath the jacket 112.

Further, the jacket 112 is particularly advantageous in low ambient temperatures. For example, although cold weather installation of the cable connector 150 onto a standard rigid jacketed cable can be difficult or impossible due to the increased rigidity of the jacket in cold temperatures, the cable connector 150 can be installed with relative ease onto the example coaxial cable 100 in cold weather due to the required insertion force being considerably reduced by virtue of the reduced amount of jacket material that the post 152 must displace. Therefore, the cable connector 150 can be installed on the example coaxial cable 100 in cold weather where installation was previously difficult or impossible with a standard rigid-jacketed cable. At the same time, the relatively rigid jacket 112 provides the protection necessary for the internal components of the coaxial cable 100.

One advantage of the design of the jacketed cable 100 is the decreased connector insertion force required to install the connector 150 onto the example cable 100. For example, the insertion force required to attach the connector post 152 of the connector 150 onto the example cable 100 is less than the insertion force required to attach the same connector post 152 onto a standard rigid-jacketed cable. This decrease in the required insertion force is due to the reduced amount of material of the jacket 112 that the post 152 must displace during post insertion.

### II. Example Method for Manufacturing a Coaxial Cable

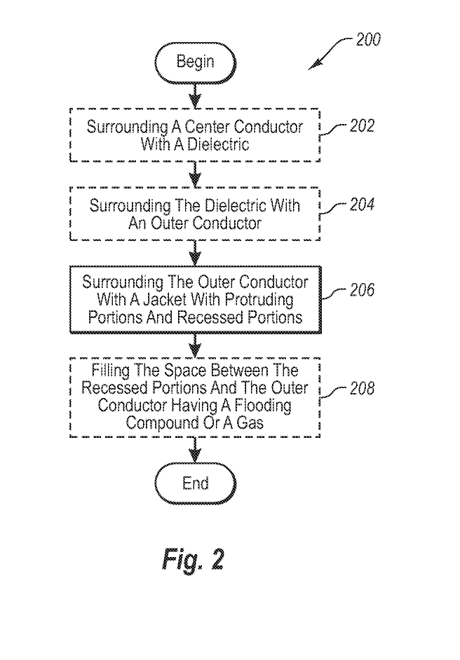

With continued reference to FIGS. 1B and 1C, and with reference also to FIG. 2, an example method 200 for manufacturing the example coaxial cable 100 is disclosed.

At step 202, the center conductor 102 is surrounded with the dielectric 104. For example, the center conductor 102 can be fed through a first extruder where a pre-coat of a bonding agent, such as a polymer, is applied. The pre-coated center conductor 102 can then be fed through a second extruder where the dielectric 104 is applied so as to surround the center conductor 102. Alternatively, the step 202 may be omitted altogether where the center conductor 102 has been surrounded with the dielectric 104 prior to the performance of the example method 200.

Next, at step 204, the dielectric 104 is surrounded with the outer conductor 106. As noted above, the outer conductor 106 can be formed from alternating layers of tape and/or braid. For example, the dielectric 104 and the component(s) it surrounds can be fed through one or more wrapping operations that each wraps a layer of tape around the dielectric 104, such as the tape 108. Similarly, each layer of tape can be fed through one or more braiding operations that each braid, weave, or wrap a layer of braid around each layer of tape, such as the braid 110 for example. Alternatively, the step 204 may be omitted altogether where the dielectric 104 has been surrounded with the outer conductor 106 prior to the performance of the example method 200.

Then, at step 206, the outer conductor 106 is surrounded with the jacket 112 having protruding portions 112a and recessed portions 112b. For example, the outer conductor 106 and the components it surrounds can be fed through a third extruder where the jacket 112 is applied so as to surround the outer conductor 106. The extruder may include a die configured to form the protruding portions 112a and the recessed portions 112b in the jacket 112.

In addition, the die may be configured to cause the protruding portions 112a to be helically wrapped along the length of the coaxial cable 100. This helically wrapping of the protruding portions 112a can be accomplished, for example, by forming the die to have vanes or ridges that are positioned at an angle that is offset from the axis of protrusion, or by rotating the pull-off spool or the die itself at a predetermined angle per length of cable while passing the cable 100 through the die. It is also noted this helically wrapping of the protruding portions 112a can alternate between a clockwise and a counter-clockwise helically wrapping along the length of the cable 100.

Finally, at step 208, the space between each recessed portion 112b and the nearest internal component, such as the braid 110, is filled with a flooding compound or a gas. For example, a flooding compound may be injected into the space between each recessed portion 112b and the braid 110, through a tip of the die for example, in order to prevent this space from collapsing while the jacket 112 cools and hardens. The flooding compound can later prevent moisture from entering this space and may also function as a lubricant to facilitate the slipping of a post of a cable connector underneath the jacket 112. Alternatively, a gas may be injected into the space between each recessed portion 112b and the braid 110, through a tip of the die for example, in order to prevent this space from collapsing while the jacket 112 cools and hardens. This gas may be an inert gas such as helium, neon, argon, krypton, xenon, carbon dioxide, nitrogen, or some combination thereof. Alternatively, the step 208 may be omitted altogether where the space between each recessed portion 112b and the braid 110 is maintained using methods other than filling with a flooding compound or a gas while the jacket 112 is cooled and hardened. Alternatively, a foam material may be injected in the space between each recessed portion 112b and the braid 110. This foam material may be a structurally substantial foam such as a polyethylene foam, for example.

Thus, the example method 200 can be employed to form the example coaxial cable 100. As disclosed elsewhere herein, the relative decrease in the amount of jacket material making contact with the internal components of the coaxial cable 100 reduces the amount of insertion force required to fully insert the post of a cable connector underneath the jacket 112. This is due in part to the decrease in the amount of jacket material that the post must displace as the post is inserted underneath the jacket 112. In addition, the extent of any helically wrapping of the protruding portions 112a may be configured to either contribute to or offset the bending bias of the braid 110, thereby either increasing or decreasing, respectively, the effect of the bending bias of the braid 110 on the coaxial cable 100.

### III. Alternative Embodiments

Although the example embodiments are described in the context of a standard coaxial cable, it is understood that other cable configurations may likewise benefit from the jacket 112 disclosed herein. For example, tri-shield cable (where the outer conductor includes one braid layer and two tape layers) and quad-shield cable (where the outer conductor includes two braid layers and two tape layers), and messengered coaxial cable (where the cable includes a messenger wire embedded in the jacket that provides support in situations where the cable aerially spans long distances, such as 75 feet or more) can be configured to include the jacket 112. In addition, although the example cable connectors 150 disclosed herein are configured as standard male F-type connectors, other connectors or cable components that include a post (or similar structure) that must slide underneath or otherwise mate with the cable jacket can similarly benefit from the jacket 112 disclosed herein. For example, connectors for radio communications having type N or type BNC interfaces, or connectors for audio purposes having RCA or phone plugs, can benefit from the jacket 112.

Further, although the internal components of the example coaxial cable 100 include a center conductor 102, a dielectric 104, and an outer conductor 106, it is understood that cables with other types of internal components can similarly benefit from a jacket of the sort claimed herein. In general, any cable, with any combination of internal components, that can be terminated with a connector (or similar component) that includes a post that must slide underneath or otherwise mate with the cable jacket can similarly benefit from the inventive concepts disclosed herein.

The example embodiments disclosed herein may be embodied in other specific forms. The example embodiments disclosed herein are to be considered in all respects only as illustrative and not restrictive.

What is claimed is:

1. A coaxial cable comprising:
two or more internal components comprising an electrical conductor configured to propagate a signal and an outer conductor surrounding the electrical conductor; and
a jacket surrounding the internal components, the jacket comprising:
two or more protruding portions; and
two or more recessed portions each positioned between two of the protruding portions,
wherein each of the protruding portions makes contact with the outer conductor and each of the recessed portions does not make contact with the outer conductor.

2. The coaxial cable as recited in claim 1, wherein a contact surface area between each protruding portion and the outer conductor is less than or equal to about one-third of a surface area of the outer conductor underneath each recessed portion.

3. The coaxial cable as recited in claim 1, wherein a space between each recessed portion and the outer conductor is filled with a flooding compound.

4. The coaxial cable as recited in claim 3, wherein the flooding compound comprises polybutane, amorphous polypropylene, polyisobtylene, or some combination thereof.

5. The coaxial cable as recited in claim 1, wherein the jacket comprises polyethylene (PE), high-density polyethylene (HDPE), low-density polyethylene (LDPE), linear low-density polyethylene (LLDPE), or some combination thereof.

6. A coaxial cable comprising:
a center conductor configured to propagate a signal;
a dielectric surrounding the center conductor;
an outer conductor surrounding the dielectric; and
a jacket surrounding the outer conductor, the jacket comprising:
two or more recessed portions; and
two or more protruding portions each positioned between two of the recessed portions.

7. The coaxial cable as recited in claim 6, wherein the outer conductor comprises:
one or more tape layers; and
one or more braid layers, each braid layer being adjacent to a tape layer.

8. The coaxial cable as recited in claim 7, wherein the protruding portions are helically wrapped along the length of the coaxial cable.

9. The coaxial cable as recited in claim 8, wherein the protruding portions offset a bending bias of the one or more braid layers.

10. The coaxial cable as recited in claim 8, wherein the protruding portions contribute to a bending bias of the one or more braid layers.

11. The coaxial cable as recited in claim 6, wherein the jacket comprises PE, HDPE, LDPE, LLDPE, or some combination thereof.

12. A method for manufacturing a coaxial cable having two or more internal components comprising an electrical conductor configured to propagate a signal and an outer conductor surrounding the electrical conductor, the method comprising the act of:
extruding a jacket so as to surround the internal components, the jacket comprising:
two or more protruding portions; and
two or more recessed portions each positioned between two of the protruding portions,
wherein each of the protruding portions abuts the outer conductor and each of the recessed portions is spaced apart from the outer conductor.

13. The method as recited in claim 12, wherein a contact surface area between each protruding portion and the outer conductor is less than or equal to the surface area of the outer conductor underneath each recessed portion.

14. The method as recited in claim 12, further comprising the act of:
filling the space between each recessed portion and the outer conductor with a flooding compound.

15. The method as recited in claim 14, wherein the flooding compound comprises polybutane, amorphous polypropylene, polyisobtylene, or some combination thereof.

16. The method as recited in claim 12, further comprising the act of:
filling the space between each recessed portion and the outer conductor with a gas.

17. The method as recited in claim 16, wherein the gas comprises helium, neon, argon, krypton, xenon, or some combination thereof.

18. The method as recited in claim 12, wherein the two or more internal components further comprise a dielectric surrounding the center conductor, and the outer conductor comprises a tape layer surrounding the dielectric and a braid layer surrounding the tape layer.

19. The method as recited in claim 18, wherein the protruding portions are helically wrapped along the length of the coaxial cable and offset a bending bias of the braid layer.

20. The method as recited in claim 12, wherein the jacket comprises PE, HDPE, LDPE, LLDPE, or some combination thereof.
